(19) United States
(12) Patent Application Publication
(10) Pub. No.: US 2018/0025012 A1
(43) Pub. Date: Jan. 25, 2018

(54) WEB PAGE CLASSIFICATION BASED ON NOISE REMOVAL

(71) Applicant: Fortinet, Inc., Sunnyvale, CA (US)

(72) Inventors: Xiping Cao, Coquitlam (CA); Ye Ma, Burnaby (CA)

(73) Assignee: Fortinet, Inc., Sunnyvale, CA (US)

(21) Appl. No.: 15/214,245

(22) Filed: Jul. 19, 2016

(51) Int. Cl. G06F 17/30; H04L 29/08

(52) U.S. Cl. CPC G06F 17/3089; H04L 67/02; G06F 17/30601; G06F 17/30882

(57) ABSTRACT

Systems and methods for improving accuracy of web content classification by removing perceived noise are provided. The system receives a Uniform Resource Locator (URL) of a web page that needs to be classified, and parses the web page so as to construct a tree containing a list of tags. Unwanted tags are removed from the list of tags to yield a tree containing only desired tags that form part of the web page. Subsequently, a list of hyperlinks are based on processing of the tree having desired tags, wherein the list of hyperlinks can include unwanted/undesired/invalid hyperlinks and valid hyperlinks. Unwanted hyperlinks can accordingly be removed from the list of hyperlinks, and each valid hyperlink can be categorized based on a list of categories, and a final category for the web page is determined based on a vector analysis of each category assigned to each valid hyperlink.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2016, Fortinet, Inc.

### BACKGROUND

### Field

Embodiments of the present invention generally relate to web page classification. In particular, embodiments of the present invention relate to systems and methods for web page classification/categorization based on removal of noisy content/tags/hyperlinks, and classifying the web page based on the remaining meaningful content/hyperlinks.

### Description of the Related Art

The Internet has become indispensable in many aspects of our lives. The importance of the Internet lies in providing users access to an enormous amount of data related to almost any conceivable subject. The amount of data available on the Internet is enormous and the enormity of data has its own disadvantages. A major disadvantage being difficulty in finding relevant information from the enormous amount of the data. Generally, tools like search engines assist users in locating information on the Internet. However, search engines generally provide users with a large number of web pages in response to keywords provided by the user.

The Internet of today has billions of web pages that include different types of content, some of which may be essential while others may be undesired for a particular user or category of users. Web pages need to be classified and/or marked as being associated with certain categories so as to help network devices/applications to filter network traffic, and/or inform network administrators/users about the type of content that the requested web page contains. Web page classification, also known as web page categorization is a process of classifying web pages into different meaningful categories. Web pages need to be classified for different purposes, including, but not limited to providing relevant web directories/pages to a search user, to improving the quality of search results, blocking/filtering web pages that contain objectionable material/content, developing a knowledge bank, conducting web page indexing, data mining, and other such proposes. When a user searches for a particular keyword, the percentage of relevant results are increased through web page classification and indexing by providing results pertaining to web pages belonging to the category of interest to the user. Similarly, web page classification can also be used for blocking web pages by network security devices/applications as the web pages may belong to restricted categories such as pornography, hate speech, potentially malicious sites and the like.

Many approaches for web page classification have been proposed over the years. However, none of the known web page classification systems are able to classify a web page accurately with high consistency. Performance of web page classifiers have improved from different perspectives, namely by dimensionality reduction (feature selection), using word occurrence statistics in a web page (content based), using the relationship between different web pages (link based), using associations between queries and web pages (query log based), and by using the structure of the page, the images, links contained in the page and their placement (structure based).

Three distinct features of a web page namely, the Uniform Resource Locator (URL), title, and metadata which are believed to have more predictive information about a web page are used with machine learning methods to classify a web page into different categories. In prior solutions, web page classification has been performed manually and/or automatically, wherein once such classification is performed, the web pages may be identifiable through such classification. However, manual web page classification may be a difficult and time consuming technique in cases where the volume of data available on the web is enormous.

The heterogeneous nature of web pages further adds to the complexity of classification systems as different web pages use different formatting, alignment, content type, language, web scripts, and contain different content. For example, web pages may be unstructured documents such as text document, semi structured documents like HyperText Markup Language (HTML) files, or fully structured documents like Extensible Markup Language (XML) files. Web pages may also contain files of various formats such as image files, audio files, and video files, and therefore distinct varieties of the web pages may pose a challenge in web page classification.

Existing web-page classification systems typically use the complete content and hyperlinks of a web page for performing classification, regardless of their relevance to the web page, and hence do not yield the most accurate classification. For example, a web page having a beautifully captured natural scene may also include comments from different people who may have posted their feedback, such as superb, sexy, beautiful, etc. Existing web page classification systems, in such cases, may classify the web page in a restricted category due to the appearance of the word “sexy” in the comment section. Existing systems therefore tend to analyze all content on the web page in a similar/equal manner, and may not be able to differentiate the actual content from associated advertisement/copyright/feedback related content. In another example, a web page may include some declarations and/or general legal notices, and the web page may, based on the same, be classified into a legal category due the words/language used. However, the web page may be a mere news page including these legal clauses as part of a disclaimer. On a typical web page, especially on a dynamic web page, there may be similar noisy content, which may lead to incorrect classification of the web page. As those skilled in the art will appreciate, incorrect classification of web pages may prompt complaints from users/partners, and affect their confidence about the web page classification system as some web pages may unnecessarily be blocked while some other unwanted web pages may be avoid filtering due to incorrect classification.

### SUMMARY

Systems and methods are described for improving accuracy of web content classification by removing perceived noise. According to one embodiment, a system receives a Uniform Resource Locator (URL) of a web page to be classified, and parses the web page so as to construct a tree containing a list of tags. Unwanted tags are removed from the list of tags to yield a tree containing only desired tags that form part of the web page. Subsequently, a list of hyperlinks are based on processing of the tree having desired tags, wherein the list of hyperlinks can include unwanted/undesired/invalid hyperlinks and valid hyperlinks. Unwanted hyperlinks can accordingly be removed from the list of hyperlinks, and each valid hyperlink can be categorized based on a list of categories, and a final category for the web page is determined based on a vector analysis of each category assigned to each valid hyperlink.

Other features of embodiments of the present disclosure will be apparent from accompanying drawings and from detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary high-level web page classification architecture in which or with which embodiments of the present invention can be implemented.

FIGS. 2A and 2B illustrate exemplary module diagrams for a web page classification system in accordance with an embodiment of the present invention.

FIGS. 3A to 3C are flow diagrams illustrating noise and irrelevant hyperlink removal processing for web page classification in accordance with an embodiment of the present invention.

FIG. 4 illustrates in tabular form a list of valid hyperlinks of a web page, corresponding categories for each valid hyperlink and a resulting category vector based on such classification in accordance with an embodiment of the present invention.

FIG. 5 is a flow diagram illustrating web page classification processing in accordance with an embodiment of the present invention.

FIG. 6A illustrates an exemplary tree constructed for a given URL in accordance with an embodiment of the present disclosure.

FIG. 6B illustrates an exemplary diagram of filtering hyperlinks and classification of a web page for a given URL in accordance with an embodiment of the present disclosure.

FIG. 7 illustrates an exemplary computer system in which or with which embodiments of the present invention may be utilized.

### DETAILED DESCRIPTION

Systems and methods are described for improving accuracy of web content classification by removing perceived noise. Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

If the specification states a component or feature “may”, “can”, “could”, or “might” be included or have a characteristic, that particular component or feature is not required to be included or have the characteristic.

Although the present disclosure has been described with the purpose of web page classification, it should be appreciated that the same has been done merely to illustrate the disclosure in an exemplary manner and any other purpose or function for which the explained structure or configuration can be used, is covered within the scope of the present disclosure.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

Systems and methods are described for improving accuracy of web content classification by removing perceived noise. In an aspect, a Uniform Resource Locator (URL) of a web page that needs to be classified (also referred to as “categorized” hereinafter) is received, and a tree representing layout and hierarchy of tags that form part of the web page is constructed using a parser. As the tags can include unwanted tags and desired tags, the unwanted tags are removed to yield a modified tree containing only desired tags that form part of the web page. Subsequently, based on processing of the desired tags, hyperlinks are retrieved from the web page, which can include unwanted hyperlinks and valid hyperlinks, wherein the unwanted hyperlinks, which can include irrelevant hyperlinks, stop hyperlinks, and hyperlinks having a distance greater than a defined threshold from a valid hyperlink, are removed, and a classification is determined and associated with each valid hyperlink so as to finally perform vector analysis based classification in order to associate a class/category with the web page for which the URL was received, wherein the classification is based on the valid hyperlinks and desired tags.

In an aspect, a system for web page classification is described. The system includes a non-transitory storage device having therein one or more routines operable to facilitate categorization of content of a web page, and one or more processors coupled to the non-transitory storage device and operable to execute the one or more routines. In an exemplary implementation, the one or more routines can include a URL receive module to receive a URL of a web page that has to be classified, wherein the web page can be in the form of a HyperText Markup Language (HTML) or an extensible HyperText Markup Language (XHTML) document and any other web language.

The system can further include a URL tree construction module that can, responsive to receiving the URL of the web page, parse the web page using an HTML parser or API to construct a tree representing layout and hierarchy of tags representing the web page. In an aspect, the tree can include unwanted/undesired tags and desired tags. In an exemplary implementation, the system can further include a tag based filtration module that can filter a first set of tags (also interchangeably referred to as undesired/unwanted tags) to obtain the desired tags that are indicative of relevant and actual content displayed by the webpage. The undesired tags can include, but are not limited to, tags indicative of display parameters of the web page, tags indicative of a template associated with the web page, tags indicative of layout parameters of the web page, tags indicative of advertisement information to be displayed concurrently with the content of the web page, leaf node tags, and tags indicative of formatting attributes of the web page, etc. On the other hand, the desired tags can include tags indicative of relevant and actual content displayed by or linked by the web page. In an aspect, the tag based filtration module can remove (also referred to as “reject” or “filter out” hereinafter) the unwanted tags (which may also be referred to as “noise” hereinafter), leaving behind the desired tags in the tree.

The system can further include a hyperlink list retrieval module that can process the modified tree containing desired tags to retrieve a list of hyperlinks that form part of the web page. These hyperlinks can include unwanted hyperlinks and valid hyperlinks, wherein the unwanted hyperlinks can include irrelevant hyperlinks, stop hyperlinks, and hyperlinks having a distance from a valid hyperlink of greater than a defined threshold. On the other hand, valid hyperlinks can include hyperlinks relevant to the classification of the web page. System can further include a valid hyperlink list generation module that can process the list of hyperlinks and remove the unwanted hyperlinks leaving behind only the valid hyperlinks in a valid hyperlink list. The system can finally include a valid hyperlink list based categorization module that can process the valid hyperlink list and desired tags to associate a classification (also referred to as a class or a category) to each valid hyperlink. In an exemplary implementation, the categories can include, but are not limited to, News, Arts, Business, Sports, Porn, Hate Speech, Movies, Music, Theatre, Current affairs, Television, Entertainment, Technology, Photos, Blogs, Country, World, City, Life & Style, Malicious URL, Phishing URL, Spamming URL, Malware URL, a multi-type attack URL and other like categories. Subsequently, a category vector containing each valid hyperlink and its associated category can be generated, and a final category can be determined for the URL/webpage based on the category, from the one or more associated categories assigned to the valid hyperlinks, that has the highest count. In an aspect, one or more sub-categories of the finally selected cateogry(ies) can also be determined for efficient and more accurate classification of the web page/URL.

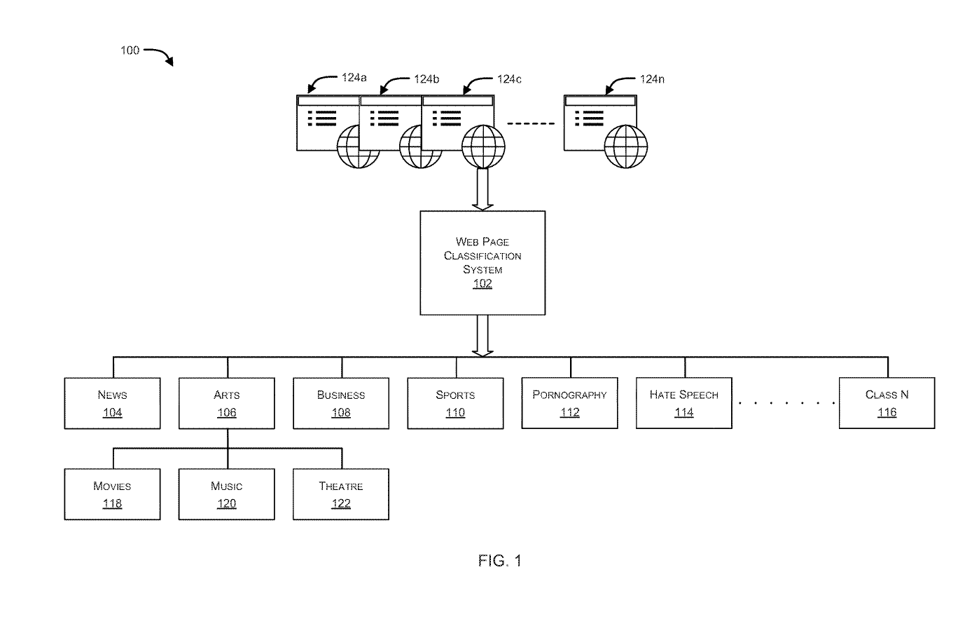

FIG. 1 illustrates an exemplary high-level web page classification architecture 100 in which or with which embodiments of the present invention can be implemented. In the context of the present example, a web page classification system 102 can classify a web page, for example, 124a, 124b, . . . , 124n into one or more of a number of available categories, e.g., News 102, Arts 106, Business 108, Sports 110, Porn 112, Hate Speeches 114, Movies 118, Music 120, Theatre 122, Current Affairs, Television, Entertainment, Technology, Photos, Blogs, Country, World, City, Life & Style, Malicious URL, Phishing URL, Spamming URL, Malware URL, a multi-type attack URL, and the like.

In one embodiment, web page classification system 102 can determine/assign/associate categories as well as sub-categories, for example under class/category arts 106, a list of sub-classes, for example, movies 118, music 120, theatre 122 etc. can be defined. In an embodiment, any number of new classifications/categories can be added to or removed from or modified in such a list, wherein such classifications can either be manually added or can be automatically maintained in real-time based on one or more repository or classification databases/data structures. In an exemplary implementation, these categories and/or classification can be predefined, and can also be created in real-time by the system.

In an embodiment, a parser, responsive to receiving a Uniform Resource Locator (URL) of a web page, can create a tag tree that can include unwanted tags (which may also be interchangeably referred to as undesired tags) and desired tags, wherein unwanted tags can be removed so as to obtain desired tags that are indicative of relevant and actual content. Subsequently, a list of hyperlinks can be retrieved from the modified tree having only the desired tags that form part of the web page, where these hyperlinks can undergo a noise removal process in order to obtain a list of valid hyperlinks. A category (which may also be interchangeably referred to as a class or a classification), from a list of categories, can then be associated with each valid hyperlink, and finally, based on vector analysis, the web page for which the URL was received, can be classified as being associated with at least one final category.

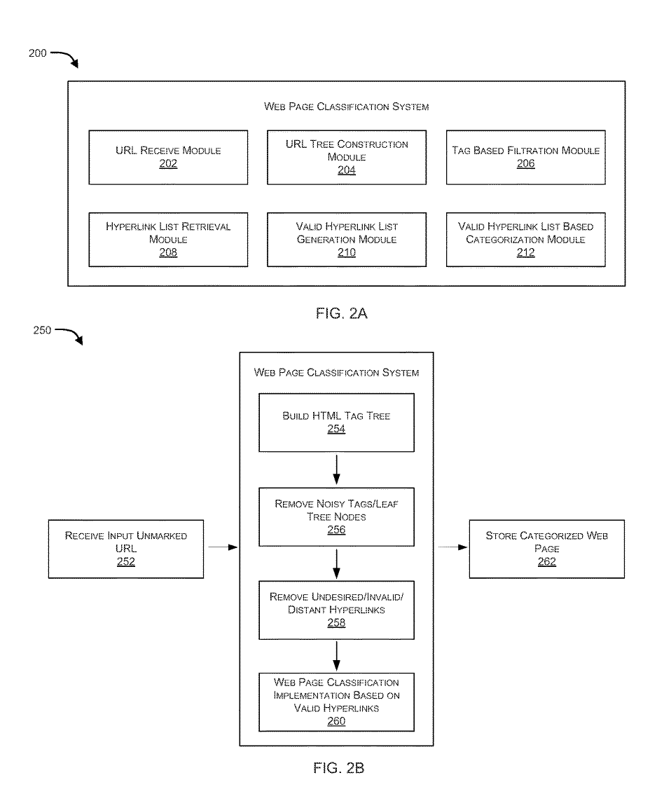

FIGS. 2A and 2B illustrate exemplary module diagrams 200 and 250 for a web page classification system in accordance with an embodiment of the present invention. FIG. 2A illustrates an exemplary module diagram 200 for a web page classification system, wherein the system can include a URL receive module 202, a URL tree construction module 204, a tag based filtration module 206, a hyperlink list retrieval module 208, a valid hyperlink list generation module 210, and a valid hyperlink list based categorization module 212.

In an embodiment, the URL receive module 202 can be configured to receive a URL of a web page that is to be classified, wherein the web page can be in a form of a HyperText Markup Language (HTML) or an extensible HyperText Markup Language (XHTML) document. Subsequent to receiving the URL, the URL tree construction module 204 can be configured to construct a tree using an HTML parser or an Application Programming Interface (API), for the given web page, wherein the tree represents a layout and hierarchy of tags that are used to represent the web page.

In an aspect, tag based filtration module 206 can be configured to remove unwanted tags generated by the URL tree construction module 204. As the tree generated by module 204 may include both unwanted tags and desired tags, filtration module 206 can remove the unwanted tags, which can include tags indicative of, for instance, display parameters of the web page, tags indicative of a template associated with the web page, tags indicative of layout parameters of the web page, tags indicative of advertisement information to be displayed concurrently with the content of the web page, leaf node tags, and tags indicative of formatting attributes of the web page. Desired tags, on the other hand, can include tags indicative of relevant and actual content displayed by or linked by the web page. Subsequent to filtering out of the unwanted tags, desired tags that are indicative of relevant and actual content displayed by or linked by the web page remain in the tree, which may also be interchangeably referred to as a modified tree hereinafter.

In an aspect, hyperlink list retrieval module 208 can be configured to process the desired tags, and retrieve a list of hyperlinks that form part of the web page. These hyperlinks may include both unwanted hyperlinks and valid hyperlinks, wherein the unwanted hyperlinks can include irrelevant hyperlinks, stop hyperlinks, and hyperlinks having a distance greater than a defined threshold (say, three intermediate nodes) from a valid hyperlink. Valid hyperlinks include hyperlinks that are relevant to classification of the web page and are therefore accordingly retained. Valid hyperlink list generation module 210 can be configured to process the list of hyperlinks and remove unwanted hyperlinks, wherein subsequent to the removal of unwanted hyperlinks from the list of hyperlinks, valid hyperlinks that are relevant to the web page can be retained, for instance in a valid hyperlink list.

In an embodiment, valid hyperlink list based categorization module 212 can be configured to process the valid hyperlink list to associate a category with each valid hyperlink, wherein the category can be selected from one or more categories, including, but not limited to News, Arts, Business, Sports, Porn, Hate Speeches, Movies, Music, Theatre, Current affairs, Television, Entertainment, Technology, Photos, Blogs, Country, World, City, Life & Style, Malicious URL, Phishing URL, Spamming URL, Malware URL, a multi-type attack URL and the like. In an aspect, multiple sub-cateogries can be defined for each category, wherein one or more sub-cateogries can be associated with or assigned to each hyperlink. In an embodiment, once the classification is completed for all valid hyperlinks, a category vector containing information regarding the valid hyperlinks observed within the web page along with their respective categories can be generated, and a final category, based on the category having the highest value in the vector, can be associated with the web page for which the URL was received. In an exemplary implementation, Naive Bayes classifier can be used by the module 212 to classify the valid hyperlinks and finally to classify the web page.

FIG. 2B illustrates an exemplary block diagram 250 for a web page classification system. As shown in FIG. 2B, the system can receive, as input, an unmarked URL 252, upon receipt of which, the system can build an HTML tag tree 254 based on tags that form part of the web page specified by the URL, remove noisy tags/leaf tree nodes 256 to identify desired tags, remove undesired/invalid/distant hyperlinks 258 based on processing of the desired tags, and perform web page classification processing based on remaining/valid hyperlinks 260 and desired tags so as to store categorized web page 262. In an exemplary implementation, the system can be configured to automatically retrieve new URLs and classify them into suitable categories and sub-categories. For example, retrieval of a new URL can be based on the last URL explored and classified, or can be a URL being accessed by a user of a protected network.

In an embodiment, the system can receive an input unmarked URL 252 of a web page that needs to be categorized, wherein the web page can be represented either in the form of an HTML or as an XHTML document or in any other suitable format such that subsequent to receiving the URL 252, the system can build an HTML tag tree 254 using a suitable HTML parser or API, wherein the HTML tag tree represents layout and hierarchy of tags. As a given HTML tag tree may include one or more noisy tags, for example, tags having no relevance to the content of the web page, including, but not limited to, tags indicative of display parameters of the web page, tags indicative of a template associated with the web page, tags indicative of layout parameters of the web page, tags indicative of advertisement information to be displayed concurrently with the content of the web page, leaf node tags, and tags indicative of formatting attributes of the web page, the system can remove such noisy tags and undesired leaf nodes as shown at block 256.

In an embodiment, the system can also be configured to retrieve all hyperlinks present in the web page identified by a given URL and process such hyperlinks so as to remove the undesired, invalid and distant hyperlinks, as shown at block 258. By removing/rejecting the undesired hyperlinks, invalid hyperlinks, stop hyperlinks and distant hyperlinks, the system can obtain a list of valid hyperlinks, which can be used to enable determination of an appropriate and accurate category for a given URL.

In an aspect, the system can also determine and associate a class for each node that represents a valid hyperlink in the tree, and collectively determine a final category for the given URL. In another aspect, once the classification for all of the valid hyperlinks is completed, a category vector containing information regarding a number of valid hyperlinks observed within the web page that are associated with different categories, can be generated and the final category, based on the category from the plurality of categories whose number is greatest, can be associated with the web page specified by the received URL.

In another aspect, the system can store the categorized web page in an appropriate database/repository, as shown at block 262. The system can also maintain a physical/logical table of URLs along with their mapped/associated respective categories so as to use such categories for future actions such as blocking the URLs or prioritizing the URLs or for any other intended objective.

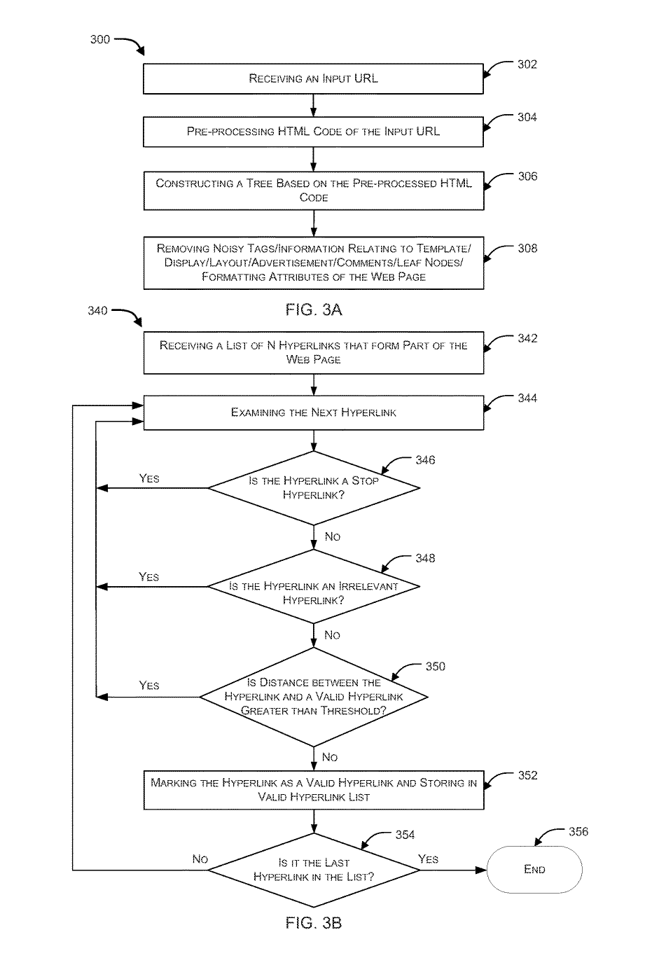

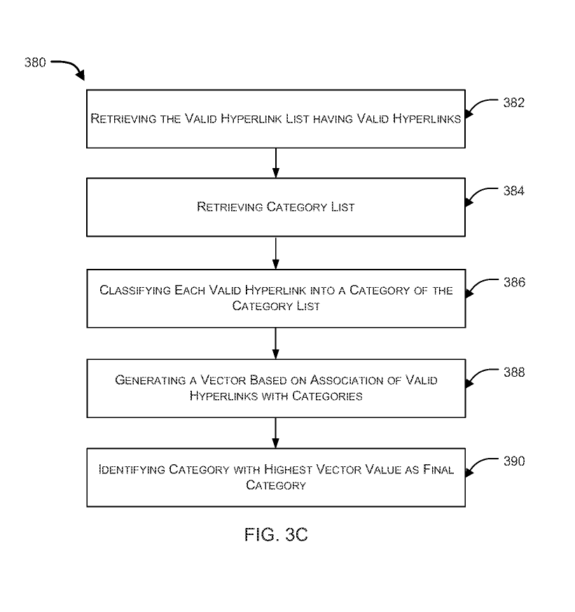

FIGS. 3A to 3C are flow diagrams 300, 340, and 380 illustrating noise and irrelevant hyperlink removal processing for web page classification in accordance with an embodiment of the present invention. FIG. 3A shows a flow diagram 300 illustrating removal of noisy tags, wherein the method includes the steps of receiving an input URL as shown at step 302, pre-processing HTML code of the input URL as shown at step 304, constructing a tree based on the preprocessed HTML code as shown at step 306. Construction of HTML tag trees is well known and described in an article by Li Xiaoli and Shi Zhongzhi entitled “Innovating Web Page Classification Through Reducing Noice” J. Comput. Sci & Tecnol., Vol. 17, No. 1, January 2002, which is hereby incorporated by reference in its entirety for all purposes.

Noisy tags or noisy information relating to template, display, advertising, comments, leaf nodes, and formatting attributes are then removed as shown at step 308. The noisy tags are removed to yield a desired tag tree containing only tags that are relevant to categorization. The method can further remove or filter or reject irrelevant hyperlinks, stop hyperlinks, and hyperlinks having a distance from a valid hyperlink of greater than a predefined and/or configurable threshold so as to generate a list of valid hyperlinks.

In an embodiment, a URL received by the system can be for a web page that can be represented in a form of an HTML or an XHTML document. Subsequent to receiving the URL, the HTML codes can be pre-processed to yield an HTML tag tree for the input web page, wherein the HTML tag tree represents a layout and hierarchy of tags that are used to represent the web page. The tag tree will typically include noisy/unwanted tags along with relevant tags indicative of relevant and actual content displayed by or linked by the web page. In an exemplary implementation, noisy/unwanted tags can include, but are not limited to, tags indicative of a template associated with the web page, tags indicative of display parameters of the web page, tags indicative of layout parameters of the web page, tags indicative of advertisement information to be displayed concurrently with the content of the web page, tags indicative of comments to be displayed with the contents of the web page, leaf node tags, and tags indicative of formatting attributes of the web page. In an aspect, tags indicative of noise/unwanted elements are not relevant to the classification of the web page and can be removed to yield desired tags that are indicative of relevant and actual content displayed by or linked by the web page. The desired tags can be processed further as discussed with reference to FIG. 3B.

FIG. 3B shows a flow diagram 340 illustrating removal of unwanted hyperlinks in accordance with an embodiment of the present invention. In the context of the present example, removal of unwanted hyperlinks involves the steps of receiving a list of N hyperlinks that form part of the web page as shown at step 342; and examining each hyperlink of the N hyperlinks for removing or rejecting any or a combination of irrelevant hyperlinks, stop hyperlinks, and examining the hyperlinks having a distance from a valid hyperlink of greater than a predefined and/or configurable threshold to a list of valid hyperlinks. In one embodiment, examining each hyperlink involves selecting a hyperlink from the list of N hyperlinks and examining the hyperlink, as shown at step 344, by checking if the hyperlink is a stop hyperlink as shown at step 348, checking if the hyperlink is an irrelevant hyperlink as shown at step 350, and checking if the distance between the hyperlink and a known valid hyperlink is greater than a threshold as shown at step 352. If any of the checks result in affirmative determination, the hyperlink in question is rejected and the next hyperlink is evaluated. If the checks of steps 346-350 result in a negative determination, the hyperlink is marked as a valid hyperlink and is stored within a valid hyperlink list. The method can perform such filtering/rejection to arrive at a list of valid hyperlinks. In an exemplary implementation, the method can determine whether the hyperlink in question is the last hyperlink in the list of N hyperlinks, as shown at step 354, and stop/end the processing of filtering at that point as shown at step 356; otherwise, the method can be repeated for the next hyperlink.

In an exemplary aspect, hyperlinks associated with Sign-in, Privacy Policy, mobile feedback, return home, and the like are be examples of stop hyperlinks, On the other hand, hyperlinks associated, for instance, with language options such as EN, FR, RU, US and like are considered irrelevant hyperlinks, whereas distant hyperlinks can be identified using the k-Nearest Neighbors (kNN) algorithm. All such hyperlinks can collectively be referred to as unwanted hyperlinks and in one embodiment are not considered during classification of the web page at issue.

In one embodiment, the basic assumption for removal of distant hyperlinks is that normal data objects have a dense neighborhood and outliers are distant from their neighbors (i.e., have a less dense neighborhood). In an exemplary implementation, the distance of a hyperlink can be calculated based on distance of a hyperlink from its neighbors, wherein the distance can be calculated based on cosine similary values of the web pages at issue. In an exemplary implementation, the kNN algorithm can be used for determining a distance associated with a hyperlink. As such, for each link, its distance from its neighbor can be calculated to identify outliers. Using this approach, a list of distance summaries for each link to all other remaining links can be obtained and a threshold (e.g., 30 percent) can be used to identify outliers having content that is far away from the parent link.

In another embodiment, desired tags can be indicative of relevant and actual content displayed by or linked by the web page, yielded at step 308 of FIG. 3A, and can be processed to produce a list of hyperlinks that can be processed as shown in FIG. 3B. Subsequent to receiving the list of hyperlinks, each hyperlink can be examined to perform removal of unwanted hyperlinks, wherein, as mentioned above, an unwanted hyperlink can include a stop hyperlink or an irrelevant hyperlink or a distant hyperlink. In an implementation, steps from step 344 to step 354 can be repeated until all hyperlinks are examined one by one. If the hyperlink being examined is an unwanted hyperlink, a subsequent hyperlink can be picked from the hyperlink list for examination, whereas if the hyperlink being examined is a valid hyperlink, it can be stored in a valid hyperlink list. Once all the hyperlinks have been examined, the list of valid hyperlinks (also referred to as a valid hyperlink list) will contain only valid hyperlinks relevant to classification of the content of the web page. The valid hyperlink list can be processed further as discussed in FIG. 3C.

It is to be appreciated that as, in an exemplary implementation of the present invention, an input HTML is converted into an HTML tag tree, the system may be configured to, upon finding that a particular node/tag of the tree is undesired, automatically mark all the child nodes of the identified desired tag as undesired as well. However, this is only one exemplary implementation and may be done only for a partial/defined set of undesired tags. Any other means to automate the process of identifying undesired tags, and also for processing the desired tags to detect/retrieve unwanted/undesired hyperlinks can be incorporated to make the system more time efficient and fast, all of which possible means are well within the scope of the present disclosure.

FIG. 3C shows a flow diagram 380 illustrating determination of the final classification of a web page for which input URL is received. In the context of the present example, the determination of the final classification of a web page includes the steps of receiving a valid hyperlink list having valid hyperlinks as shown at step 382; retrieving a category list as shown at step 384; classifying each hyperlink of the valid hyperlink list into at least one category of the category list as shown at step 386; generating a vector based on association of valid hyperlinks with respective categories as shown at step 388; and identifying/determining a category with highest vector value as the final category, as shown at step 390. In an exemplary implementation, the final category can be associated with the web page for which the URL was received.

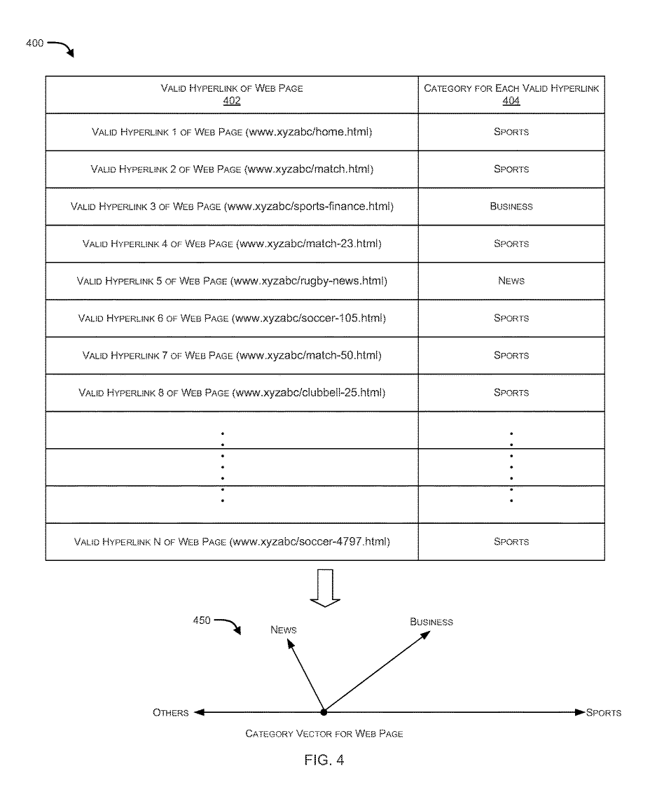

In an embodiment, valid hyperlink list created at step 352 of FIG. 3B can be received at step 382 of FIG. 3C for further processing, wherein each valid hyperlink can be examined, sequentially or in parallel, in order to associate a suitable category to the hyperlink, said category being selected from a list of predefined categories, for example, News, Arts, Business, Sports, Porn, Hate Speeches, Movies, Music, Theatre, Current affairs, Television, Entertainment, Technology, Photos, Blogs, Country, World, City, Life & Style, Malicious URL, Phishing URL, Spamming URL, Malware URL, a multi-type attack URL and the like. Once the category association step has been completed, each valid hyperlink can have a category associated with it, based on which, vector based analysis can be performed to identify the final category of the web page for which the URL was received as discussed with reference to FIG. 4 below.

FIG. 4 illustrates in tabular form 400 a list of valid hyperlinks of a web page 402, corresponding categories for each valid hyperlink 404 and a resulting category vector 450 based on such classification in accordance with an embodiment of the present invention.

Subsequent to classification of the valid hyperlinks, a category vector 450 can be generated for the web page, wherein vector 450 can include information regarding the number of valid hyperlinks observed within the web page that are associated with each assigned category such that the category that is assigned the maximum number of times can, for instance, be selected as the final category. For instance, in vector 450, the length of category for “Sports” is the longest, indicating the category “Sports” has been assigned to more of the valid hyperlinks that other categories, and therefore “Sports” can be selected as the final category for the input URL. As noted above, depending upon the particular implementation, each URL may also be, based on the system configuration, associated with one more categories and/or sub-categories.

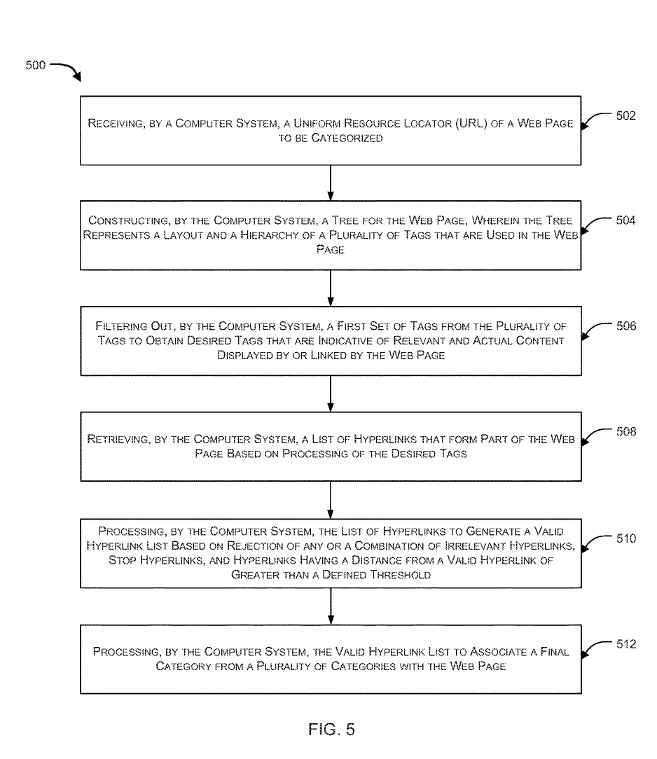

FIG. 5 is a flow diagram 500 illustrating web page classification processing in accordance with an embodiment of the present invention. The processing/method can include the steps of receiving, by a computer system, a Uniform Resource Locator (URL) of a web page to be categorized as shown at step 502; constructing, by the computer system, a tree for the web page, wherein the tree represents a layout and a hierarchy of tags that are used in the web page as shown at step 504; filtering out, by the computer system, a first set of tags to obtain desired tags that are indicative of relevant and actual content displayed by or linked by the web page as shown at step 506; retrieving, by the computer system, a list of hyperlinks that form part of the web page based on processing of the desired tags as shown at step 508; processing, by the computer system, the list of hyperlinks to generate a valid hyperlink list based on rejection of irrelevant hyperlinks, stop hyperlinks, and hyperlinks having a distance from a valid hyperlink of greater than a defined threshold as shown at step 510; and processing, by the computer system, the valid hyperlink list to associate a final category from a list of categories with the web page as shown at step 512.

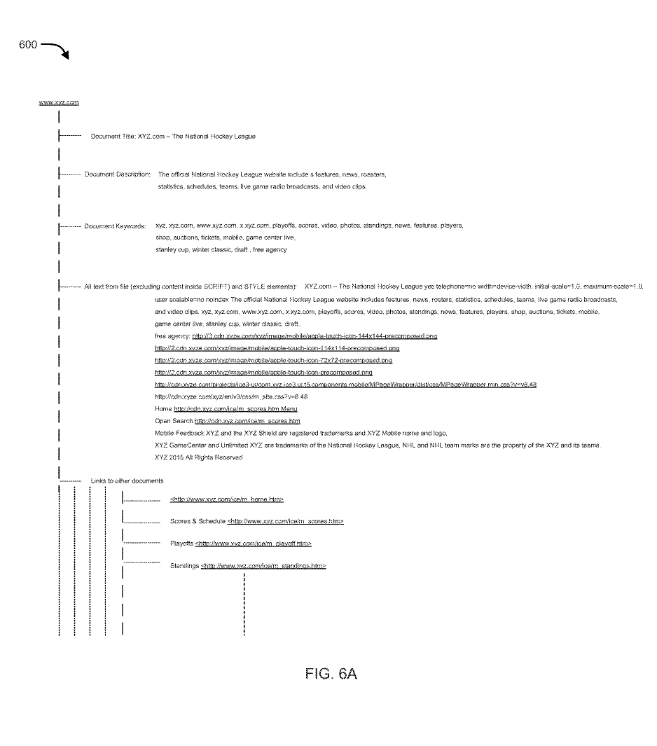

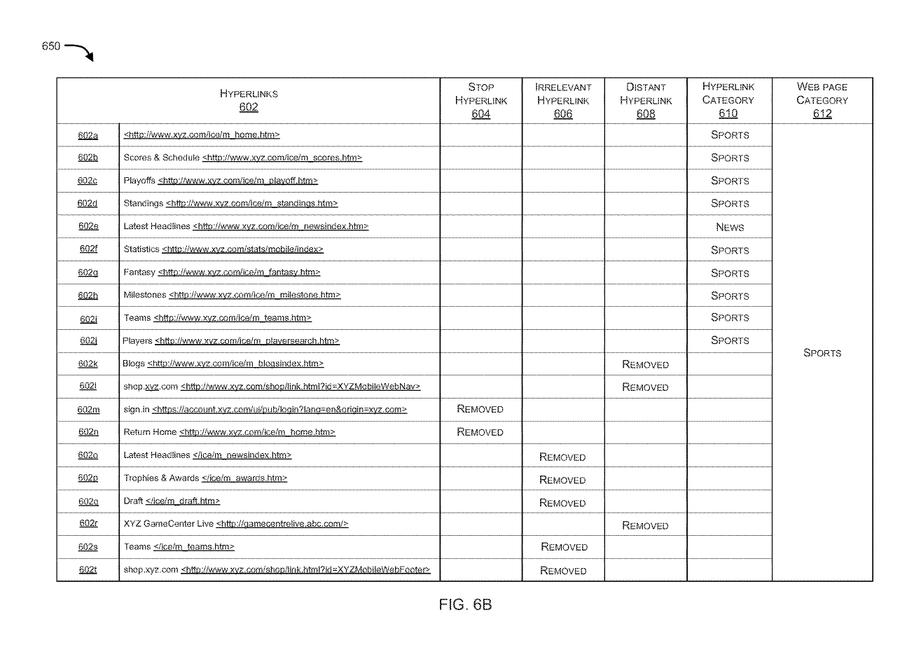

FIG. 6A illustrates an exemplary tree 600 constructed for a given URL in accordance with an embodiment of the present invention. For a given URL, for example www.xyz.com, that may be in the form of an HTML document, different tags such as <title>, <H1>, <A HERF . . . >, <Meta name=“description” content=“. . . ”> <Meta name=“keywords”, content=“. . . ”> and <Meta name=“classfication”, content=“. . . ”>, <Body>, <frame>. . . etc. can be retrieved, wherein a suitable HTML parser can parse the tags and enable generation of a tree representing layout and hierarchy of the tags. In an exemplary implementation, undesired tags can be removed and/or rejected so as to obtain a list of desired tags that are indicative of relevant and actual content. Undesired tags can include tags that are indicative of display parameters of the web page, tags indicative of a template associated with the web page, tags indicative of layout parameters of the web page, tags indicative of advertisement information to be displayed concurrently with the content of the web page, leaf node tags, and tags indicative of formatting attributes of the web page.

FIG. 6B illustrates an exemplary diagram of filtering of hyperlinks and classification of a web page for a given URL in accordance with an embodiment of the present invention. In an exemplary implementation, after removal of the undesired tags (though the step need not be executed sequentially), a list of hyperlinks 602 that form part of the web page of input URL www.xyz.com can be retrieved, and each hyperlink can be evaluated and marked as any of a stop hyperlink 604, irrelevant hyperlink 606, distant hyperlink 608 or as a valid hyperlink 602. As explained earlier, hyperlinks marked as stop hyperlinks, irrelevant hyperlinks, and distant hyperlinks can be removed from further consideration, thereby leaving a list of valid hyperlinks for which a category is associated based on an assessment thereof, and subsequently a final category can be associated with the entire URL/web page based on the category assigned to the most of the valid hyperlinks.

FIG. 6B lists multiple hyperlinks 602 obtained subsequent to processing of desired tags, wherein, in an example, hyperlinks associated with Sign-in, Privacy Policy, Mobile Feedback, Return Home, and like can be identified as stop hyperlinks; hyperlinks associated with “more” link, shop link, top domain name extensions, for example EN, FR, RU, US and like can be identified as irrelevant hyperlinks, and distant hyperlinks can be identified using the kNN algorithm. For instance, hyperlink 602m belongs to sign in, whereas hyperlink 602n belongs to return home, both being stop hyperlinks. As a result, hyperlinks 602m and 602n can be removed (as being stop hyperlinks 604) from the set of hyperlinks that will be used to define the classification of the web page.

Similarly, hyperlinks 602o, 602p, 602q, and 602s do not contain the web page name itself, and can be treated as irrelevant hyperlinks. Further, hyperlink 602t links to shopping, which again is an irrelevant hyperlink for web page classification purposes. As a result, hyperlinks 602o, 602p, 602q, 602s, and 602t can be removed as being irrelevant hyperlinks 606 from the list of hyperlinks that will be used to define the classification of the web page.

In the context of the present example, hyperlinks 602k, 602l, and 602r, on the other hand, are identified as distant hyperlinks based on the kNN algorithm, and as a result, hyperlinks 602k, 602l, and 602r are removed from the list of hyperlinks that will ultimately be used to classify the web page as the content of these links is far away from the parent link.

In an embodiment, subsequent to removal of unwanted hyperlinks, one or more valid hyperlinks that can be used to define the classification of the web page are left in the hyperlink list, which can now be referred to as a valid hyperlink list. As shown in FIG. 6B, 602a to 602j are the remaining hyperlinks that can be used to define classification of the web page. A hyperlink category 610 of each valid hyperlink can be examined in an iterative process, wherein the category can be compared with a defined category list, as shown in FIG. 1, which includes News 102, Arts 106, Business 108, Sports 110, Porn 112, Hate Speech 114, Movies 118, Music 120, Theatre 122, Current affairs, Television, Entertainment, Technology, Photos, Blogs, Country, World, City, Life & Style, Malicious URL, Phishing URL, Spamming URL, Malware URL, a multi-type attack URL and the like. As shown in FIG. 6B, the hyperlink 602e can be identified as belonging to “news” category and the rest of the hyperlinks belonging to “sports” category.

In an embodiment, once a classification has been identified for each valid hyperlink, a vector-based association of hyperlinks with categories can be performed, as discussed in FIG. 4, and a final category for the web page can be identified and associated therewith. As such, the final category of the exemplary web page “www.xyz.com” for which the URL was received can be identified as “Sports” as a greater number of valid hyperlinks are categorized as “Sports” than any other category.

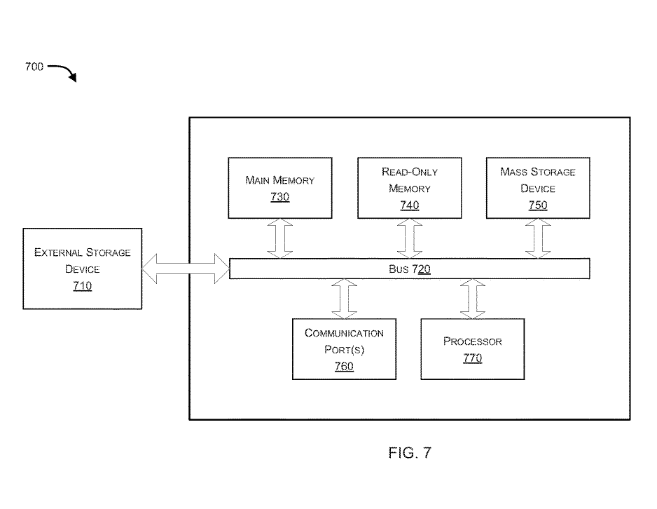

FIG. 7 illustrates an exemplary computer system 700 in which or with which embodiments of the present invention may be utilized. In an embodiment, the computer system 700 can perform the web page classification based on noise removal. Embodiments of the present disclosure include various steps, which have been described above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

As shown in the figure, computer system 700 includes an external storage device 710, a bus 720, a main memory 730, a read only memory 740, a mass storage device 750, communication port 760, and a processor 770. A person skilled in the art will appreciate that computer system 700 may include more than one processor and communication ports. Examples of processor 770 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 770 may include various modules associated with embodiments of the present invention.

Communication port 760 can be any of an RS-232 port for use with a modem based dialup connection, a 10/100 Ethernet port, a Gigabit or 10 Gigabit port using copper or fiber, a serial port, a parallel port, or other existing or future ports. Communication port 760 may be chosen depending on a network, such a Local Area Network (LAN), Wide Area Network (WAN), or any network to which computer system 700 connects.

Memory 730 can be Random Access Memory (RAM), or any other dynamic storage device commonly known in the art. Read only memory 740 can be any static storage device(s) e.g., but not limited to, a Programmable Read Only Memory (PROM) chips for storing static information e.g., start-up or BIOS instructions for processor 770.

Mass storage 750 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 720 communicatively couples processor(s) 770 with the other memory, storage and communication blocks. Bus 720 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 770 to software system.

Optionally, operator and administrative interfaces, e.g. a display, keyboard, and a cursor control device, may also be coupled to bus 720 to support direct operator interaction with computer system 700.

Other operator and administrative interfaces can be provided through network connections connected through communication port 760. External storage device 710 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. A system for web page classification comprising:
a non-transitory storage device having embodied therein one or more routines operable to facilitate categorization of content of a web page; and
one or more processors coupled to the non-transitory storage device and operable to execute the one or more routines, wherein the one or more routines include:
a Uniform Resource Locator (URL) receive module, which when executed by the one or more processors, receives a URL of a web page to be categorized;
a URL tree construction module, which when executed by the one or more processors, constructs a tree for the web page, wherein the tree represents a layout and a hierarchy of a plurality of tags that are used to represent the web page;
a tag based filtration module, which when executed by the one or more processors, filters out a first set of tags from the plurality of tags to obtain desired tags that are indicative of relevant and actual content displayed by or linked by the web page;
a hyperlink list retrieval module, which when executed by the one or more processors, retrieves a list of hyperlinks that form part of the web page based on processing of the desired tags;
a valid hyperlink list generation module, which when executed by the one or more processors, processes the list of hyperlinks to generate a valid hyperlink list based on rejection of any or a combination of irrelevant hyperlinks, stop hyperlinks, and hyperlinks having a distance from a valid hyperlink of greater than a defined threshold; and
a valid hyperlink list based categorization module, which when executed by the one or more processors, processes the valid hyperlink list to associate a final category from a plurality of categories with the web page.

2. The system of claim 1, wherein the first set of tags comprises tags indicative of display parameters of the web page, tags indicative of a template associated with the web page, tags indicative of layout parameters of the web page, tags indicative of advertisement information to be displayed concurrently with the content of the web page, leaf node tags, and tags indicative of formatting attributes of the web page.

3. The system of claim 1, wherein the valid hyperlink list based categorization module is further configured to, for each valid hyperlink in the valid hyperlink list, associate a category from the plurality of categories to the valid hyperlink, to generate a category vector containing information regarding a number of valid hyperlinks observed within the web page that are associated with the plurality of categories and to identify the final category based on the category from the plurality of categories whose number is greatest.

4. The system of claim 1, wherein the URL tree construction module is configured to preprocess the web page to construct the tree.

5. The system of claim 1, wherein the final category is associated with the URL.

6. The system of claim 1, wherein the final category is selected from any or a combination of News, Sports, Current affairs, Movies, Television, Entertainment, Business, Technology, Photos, Blogs, Country, World, City, Life & Style, Porn, Malicious URL, Phishing URL, Spamming URL, Malware URL, and a multi-type attack URL.

7. The system of claim 1, wherein the web page is assigned one or more sub-categories within the final category based on processing of the valid hyperlink list with respect to a list of available sub-categories within the final category.

8. The system of claim 1, wherein the web page is represented in a form of a HyperText Markup Language (HTML) or an extensible HyperText Markup Language (XHTML) document.

9. The system of claim 1, wherein one or more final categories are associated with the web page based on the processing of the valid hyperlink list.

10. A method comprising:
receiving, by a computer system, a Uniform Resource Locator (URL) of a web page to be categorized;
constructing, by the computer system, a tree for the web page, wherein the tree represents a layout and a hierarchy of a plurality of tags that are used in the web page;
filtering out, by the computer system, a first set of tags from the plurality of tags to obtain desired tags that are indicative of relevant and actual content displayed by or linked by the web page;
retrieving, by the computer system, a list of hyperlinks that form part of the web page based on processing of the desired tags;
processing, by the computer system, the list of hyperlinks to generate a valid hyperlink list based on rejection of any or a combination of irrelevant hyperlinks, stop hyperlinks, and hyperlinks having a distance from a valid hyperlink of greater than a defined threshold; and
processing, by the computer system, the valid hyperlink list to associate a final category from a plurality of categories with the web page.

11. The method of claim 10, wherein the first set of tags comprise tags indicative of display parameters of the web page, tags indicative of a template of the web page, tags indicative of layout parameters of the web page, tags indicative of advertisement information to be displayed concurrently with content of the web page, leaf node tags, and tags indicative of formatting attributes of the web page.

12. The method of claim 10, further comprising for each valid hyperlink in the valid hyperlink list:
associating a category from the plurality of categories to the valid hyperlink, to generate a category vector containing information regarding a number of valid hyperlinks observed within the web page that are associated with the plurality of categories; and
identifying the final category based on the category of the plurality of categories whose number is greatest.

13. The method of claim 10, further comprising pre-processing the web page to construct the tree.

14. The method of claim 10, further comprising associating the final category with the URL.

15. The method of claim 10, wherein the final category is selected from any or a combination of News, Sports, Current affairs, Movies, Television, Entertainment, Business, Technology, Photos, Blogs, Country, World, City, Life & Style, Porn, Malicious URL, Phishing URL, Spamming URL, Malware URL, and a multi-type attack URL.

16. The method of claim 10, further comprising assigning the web page to one or more sub-categories within the final category based on processing of the valid hyperlink list with respect to a list of available sub-categories within the final category.

17. The method of claim 10, wherein the web page comprises a HyperText Markup Language (HTML) or an extensible HyperText Markup Language (XHTML) document.

18. The method of claim 10, wherein one or more final categories are associated with the web page based on the processing of the valid hyperlink list.
